(19) United States
(12) Patent Application Publication
(10) Pub. No.: US 2008/0228458 A1
(43) Pub. Date: Sep. 18, 2008

(54) Radar altimeter model for simulator

(76) Inventor: Kevin Smith, Dameron, MD (US)

Correspondence Address: NAVAL AIR WARFARE CENTER AIRCRAFT;DIVISION OFFICE OF COUNSEL BLDG 435, SUITE A, 47076 LILJENCRANTZ ROAD UNIT 7, PATUXENT RIVER, MD, 20670, US

(21) Appl. No.: 11/726,204

(22) Filed: Mar. 16, 2007

(51) Int. Cl. G06G 7/62

(52) U.S. Cl. 703/13

(57) ABSTRACT

A method of simulating a radar altimeter for a simulator having an ownship includes projecting a field of view at about ninety degrees from a bottom of the ownship; determining distances from the bottom of the ownship to each pixel in the field of view; and sorting the distances to find a shortest distance. Preferably, the field of view comprises a cone. The Z-buffer of a graphics card determines the distances from the bottom of the ownship to each pixel in the field of view. The distances are sorted to find the shortest distance.

### STATEMENT OF GOVERNMENT INTEREST

The inventions described herein may be manufactured, used and licensed by or for the U.S. Government for U.S. Government purposes.

### BACKGROUND OF THE INVENTION

The invention relates in general to aircraft simulators and in particular to a radar altimeter model for an aircraft simulator.

Aircraft may be equipped with radar altimeters. A radar altimeter includes a radar device that points perpendicularly to the bottom of the aircraft and sweeps back and forth to determine the distance to objects near the aircraft. The device does not simply return the HAT (Height Above Terrain). If an aircraft banks right the radar altimeter then is pointed to 9 o'clock and will thus retrieve readings from that direction. The radar altimeter takes readings in a predetermined cone pattern. The width of this cone may vary between radar altimeter devices. The altimeter has an effective far clipping plane which limits its usefulness to a finite range. If there are no objects within this range then the radar altimeter returns null data.

Aircraft simulators are devices that simulate the operation of an actual aircraft. Aircraft simulators attempt to mimic actual aircraft controls. The more realistic the simulator, the better prepared a pilot will be when flying an actual aircraft. A part of the aircraft simulator is a model or simulation of a radar altimeter of an actual aircraft. Past radar altimeter models utilized line-of-sight vectors for range finding to objects in a scene. This method is troublesome in many respects.

First, only one line-of-sight (LOS) vector can be taken per frame (60 frames per second). Second, line-of-sight calculations carry a significant amount of computational overhead. The combination of these two issues limits the number of LOS vectors that can be taken within a given period of time. LOS vectors are drawn in a waving pattern beneath the ownship (driving airframe), to simulate a radar altimeter. The result is a set of distances taken at different times from different places. This results in inaccurate and/or erroneous data. Thus, there is a need in aircraft simulators for a device that more accurately mimics the operation of an actual radar altimeter.

### SUMMARY OF THE INVENTION

It is an object of the invention to provide an apparatus to simulate a radar altimeter of an aircraft.

One aspect of the invention is a method of simulating a radar altimeter for a simulator having an ownship, comprising projecting a field of view at about ninety degrees from a bottom of the ownship; determining distances from the bottom of the ownship to each pixel in the field of view; and sorting the distances to find a shortest distance. In one embodiment, the field of view comprises a cone having a cone angle that is adjustable. The resolution of the field of view may also be adjustable.

The step of determining distances from the bottom of the ownship to each pixel in the field of view is preferably performed by the Z-buffer of a graphics card. In one embodiment, the step of determining distances is performed about 60 times per second.

The invention will be better understood, and further objects, features, and advantages thereof will become more apparent from the following description of the, preferred embodiments, taken in conjunction with the accompanying drawings.

### BRIEF DESCRIPTION OF THE DRAWINGS

In the drawings, which are not necessarily to scale, like or corresponding parts are denoted by like or corresponding reference numerals.

FIG. 1 is a side view illustrating the concept of a radar altimeter for an aircraft.

FIG. 2 is a top view illustrating fields of view.

### DETAILED DESCRIPTION OF THE PREFERRED EMBODIMENTS

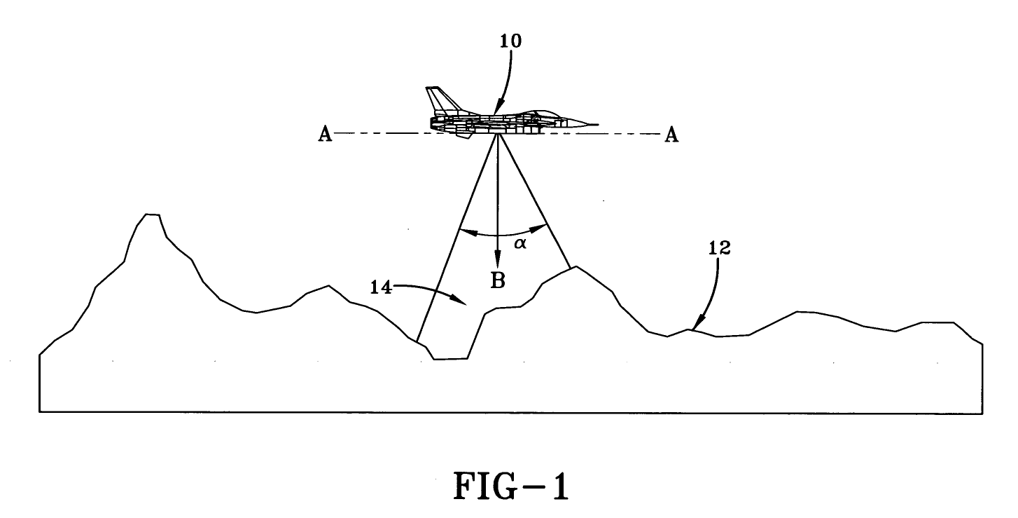

FIG. 1 illustrates the concept of a radar altimeter for an aircraft 10. Aircraft 10 is in flight above terrain 12. The bottom of aircraft 10 is in plane AA that is perpendicular to the view of FIG. 1. A radar device (not shown) points perpendicularly (in the direction of line B) from the bottom of the aircraft 10 and sweeps back and forth in a field of view (FOV) 14 to determine the distance from the bottom of the aircraft 10 to the terrain 12. Typically, the radar altimeter takes readings in a cone pattern, as shown by the angle alpha in FIG. 1.

In the invention, the aircraft 10 corresponds to the “ownship” of an aircraft simulator. The terrain 12 corresponds to the rendered terrain map of the simulator. The computer hardware and/or software of the simulator projects a FOV at about ninety degrees from the bottom of the ownship. The simulator determines the distances (or corresponding values that represent distances) from the bottom of the ownship to each pixel in the FOV. The distances are sorted to find the shortest distance from the bottom of the ownship to the rendered terrain. To be as realistic as possible, the simulated FOV preferably comprises a cone. The cone angle may be varied. An exemplary cone angle is forty-five degrees.

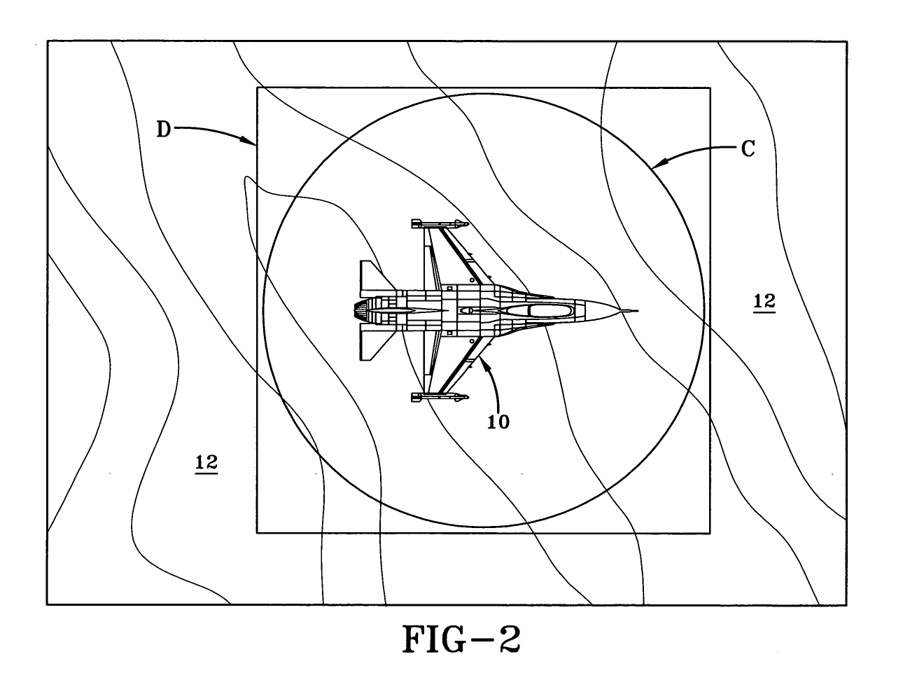

FIG. 2 is a top view of an aircraft 10 (the simulator's ownship) in flight above terrain 12 (the simulator's rendered terrain). The area of circle C represent the FOV 14 of the actual radar altimeter of the aircraft 10. The area of square D represents the FOV of the simulated radar altimeter. However, the FOV of the simulator may be “cropped” so that it coincides with the circular area C.

The radar altimeter model may be used, for example, in aircraft simulators, submersible ship simulators, surface ship simulators and similar applications. Modern graphics (video) cards utilize a “Z-buffer” to store a table of distances. The Z-buffer stores the distance from an eyepoint to each pixel of an image. This function allows the graphics card to determine which objects to draw in front and which to occlude or cull (cut out). The Z-buffer is calculated each frame for every pixel within the frame. An exemplary modern graphics cards has a resolution of at least 800×600 pixels.

The Z-buffer is a component of the inventive radar altimeter model. The values of the Z-buffer are read out each frame (60 frames per second). For an image with 800×600 resolution, there are 480,000 values a frame or 28,800,000 values a second. For each frame, a “sort” is done on the values to find the nearest pixel (closest object). The Z-buffer value for this pixel is converted to a real-world measurement and sent to the simulator. The resolution, near/far clipping planes and field of view (FOV) may be adjusted on the graphics card as necessary.

For simulating a radar altimeter, a scene size or resolution of 800×600 is more than adequate. The far clipping plane determines the distance from the eyepoint at which objects are no longer visible. The far clipping plane distance may be whatever the operating range for the simulated radar altimeter should be. An exemplary far clipping plane distance is 5000 feet. The field-of-view (FOV) may be adjusted to whatever makes sense for the radar altimeter being simulated. An exemplary FOV is 45 degrees, as shown in FIG. 1.

An advantage of using the Z-buffer is that all objects in the image are used in the computation. So, if in the simulation a bomb is dropped from the aircraft and the bomb passes beneath the aircraft, the Z-buffer will include the bomb in the image. The sorting step will return the bomb as the closest object, as is the case in an actual aircraft. LOS vectoring is not likely to pick up such objects.

The accuracy of the Z-buffer method is limited by the quality of the terrain data used to generate the rendered terrain map (i.e., a polygon mesh derived from the terrain grid postings). For high flying fixed wing aircraft Digital Terrain Elevation Data (DTED) level 1 (100 m grid postings) is satisfactory. For lower flying rotary wing aircraft or missiles DTED level 2 (30 m grid postings) or higher may be used.

While the invention has been described with reference to certain preferred embodiments, numerous changes, alterations and modifications to the described embodiments are possible without departing from the spirit and scope of the invention as defined in the appended claims, and equivalents thereof.

What is claimed is:

1. A method of simulating a radar altimeter for a simulator having an ownship, comprising:
projecting a field of view at about ninety degrees from a bottom of the ownship;
determining distances from the bottom of the ownship to each pixel in the field of view; and
sorting the distances to find a shortest distance.

2. The method of claim 1 wherein the field of view comprises a cone.

3. The method of claim 2 wherein the cone angle is adjustable.

4. The method of claim 1 wherein the step of determining distances from the bottom of the ownship to each pixel in the field of view is performed by a Z-buffer of a graphics card.

5. The method of claim 1 wherein a resolution of the field of view is adjustable.

6. The method of claim 4 wherein the step of determining distances is performed about 60 times per second.
